(19) United States
(12) Patent Application Publication
(10) Pub. No.: US 2016/0070776 A1
(43) Pub. Date: Mar. 10, 2016

(54) LOGICAL OPERATION METHOD AND INFORMATION PROCESSING DEVICE

(71) Applicant: TURBO DATA LABORATORIES, INC., Kanagawa (JP)

(72) Inventor: Shinji Furusho, Kanagawa (JP)

(21) Appl. No.: 14/784,202

(22) PCT Filed: Apr. 10, 2014
(86) PCT No.: PCT/JP2014/060386

§ 371 Date: Oct. 13, 2015

(30) Foreign Application Priority Data
Apr. 12, 2013 (JP) 2013-083879

(51) Int. Cl. G06F 17/30; G06F 17/10

(52) U.S. Cl. CPC G06F 17/30598; G06F 17/10

(57) ABSTRACT

A logical operation among plural sets in large-scale data (big data) is performed efficiently. The sets targeted for the logical operation is classified into predetermined common segments, each with a size allocatable to a memory, and the logical operation is performed with respect to each segment on the memory. The common segment is configured in such a manner that all the records of the sets are classified without duplications. Then, a direct sum of results of the logical operation on the respective segments is calculated, thereby obtaining a result of the logical operation. The size of the common segment is determined so that the records being classified are loadable on the memory.

### TECHNICAL FIELD

The present invention relates to a logical operation technique for large-scale data (big data).

### BACKGROUND ART

In recent years, the amount of data increases explosively, along with innovation of hardware such as a network, server, and storage, and with development of technique for operating those elements. This kind of data is referred to as big data. The big data is retainable on a disk, but due to its scale, it is not possible to load the entire data on a memory. Therefore, in performing a logical operation on the big data, for example, in performing the logical operation such as AND operation and OR operation among plural sets generated from the big data, it is necessary to generate subsets obtained by mechanically dividing the set into a size that allows loading on the memory, and repeat a process of the logical operation on all the combinations of the subsets. As a technique for speeding up this process, there is known MapReduce technique for parallel processing (e.g., see the Non Patent Document 1).

### PRIOR ART DOCUMENT

### Non Patent Document

Non Patent Document 1
“MapReduce”, [online], updated on Mar. 20, 2013, [retrieved on Mar. 21, 2013], the Internet, <URL:http://en.wikipedia.org/wiki/MapReduce>

### DISCLOSURE OF THE INVENTION

### Problems to be Solved by the Invention

Even when the MapReduce technique is applied to implement parallelization, the logical operation is performed exhaustively on every divisional unit obtained by dividing each set, causing an increase of the number of operations as a whole. Therefore, the processing itself may be inefficient, and also increase the number of disk accesses for loading the data on the memory, resulting in deterioration of performance in processing.

The present invention has been made in view of the foregoing circumstances, and an object of the invention is to provide a technique to perform a logical operation efficiently among plural sets in the big data.

### Means for Solving the Problem

According to the present invention, sets of records targeted for a logical operation are classified into common segments each in a size allocatable to the memory, and the logical operation is performed with respect to each segment on the memory. The common segment is configured in such a manner that all the records in each of the sets are classified without duplication. Then, a direct sum of the logical operation results of the respective segments is calculated, thereby obtaining a result of the logical operation. It should be noted that the size of the common segment is determined so that the records being classified are allowed to be loaded on the memory.

Specifically, a method of logical operation among plural sets is provided, the method classifying the records constituting the sets, into predetermined segments, with respect to each set, subjecting the records belonging to the same segment to the logical operation among the sets, obtaining a result of the operation, and calculating a direct sum of the operation results respectively of the segments, and the segment allows all the records belonging to the plural sets to be categorized uniquely.

An information processor configured to perform a logical operation among plural sets is provided, including a classifier configured to classify the records constituting the sets into predetermined segments, with respect to each set, a logical operation part configured to subject the records belonging to the same segment to the logical operation among the sets and obtain an operation result, and a direct summation part configured to calculate a direct sum of the operation results respectively of the segments, and the segment allows all the records belonging to the plural sets to be categorized uniquely.

A program is provided, causing a computer to function as a classifying means configured to classify all the records belonging to plural sets, with respect to each set, into segments allowing all the records belonging to the plural sets to be categorized uniquely, a logical operation means configured to subject the records belonging to the same segment to a predetermined logical operation among the sets and obtain a result of the operation, and a direct sum means configured to calculate a direct sum of the operation results of the respective segments.

### Effect of the Invention

According to the present invention, it is possible to efficiently perform the logical operation among plural sets in big data.

### BRIEF DESCRIPTION OF DRAWINGS

FIG. 1 is a block diagram of an information processor of an embodiment according to the present invention;

FIG. 2 illustrates an example of ordered sets of the embodiment according to the present invention;

FIG. 3 illustrates a conventional logical operation process;

FIG. 4 illustrates the conventional logical operation process;

FIG. 5 schematically illustrates the operation process of the embodiment according to the present invention;

FIG. 6 is a functional block diagram showing an operation part of the embodiment according to the present invention;

FIG. 7(a) illustrates an example of the ordered sets of the embodiment according to the present invention, FIG. 7(b) illustrates segments (baskets) of the embodiment according to the present invention, and FIG. 7(c) illustrates an example of the ordered sets after segmented;

FIG. 8 is a flowchart showing the logical operation process among the ordered sets of the embodiment according to the present invention; and

FIG. 9 illustrates the logical operation process among the ordered sets of the embodiment according to the present invention.

### BEST MODE FOR CARRYING OUT THE INVENTION

An embodiment to which the present invention is applied will now be described. Hereinafter, in all the figures illustrating the embodiment of the present invention, elements with an identical function are labeled with the same reference numeral, and they will not be redundantly explained.

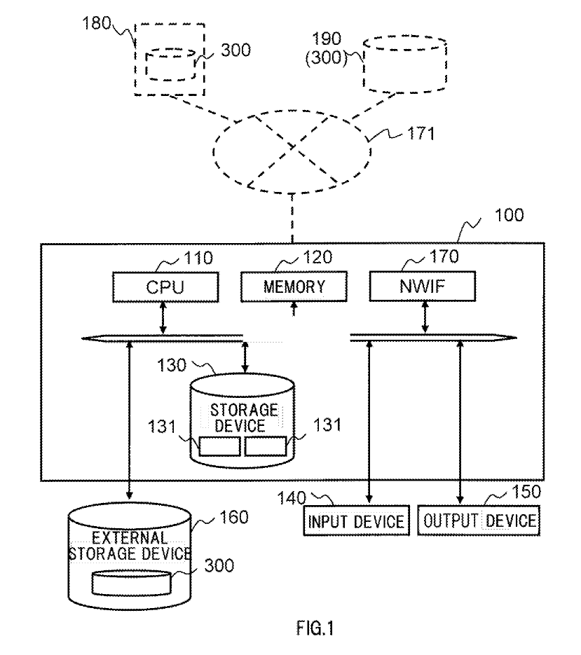

FIG. 1 is a block diagram showing an information processor 100 of the present embodiment. As illustrated, the information processor 100 of the present embodiment is provided with a CPU 110, a memory 120, a storage device 130, an input device 140, and an output device 150. It may also be provided with a network interface (NWIF) 170 and an external storage device 160.

The storage device 130 stores plural ordered sets 131 excluding duplicate records. Each of the ordered sets 131 is obtained, by searching records held in the database 300 using a predetermined item and retrieving a result of the search. It is to be noted that the database 300 may be held in the external storage device 160, and also held in another information processor 180, another external storage device 190, and the like, which are connected to the information processor 100 via the network 171, and the like.

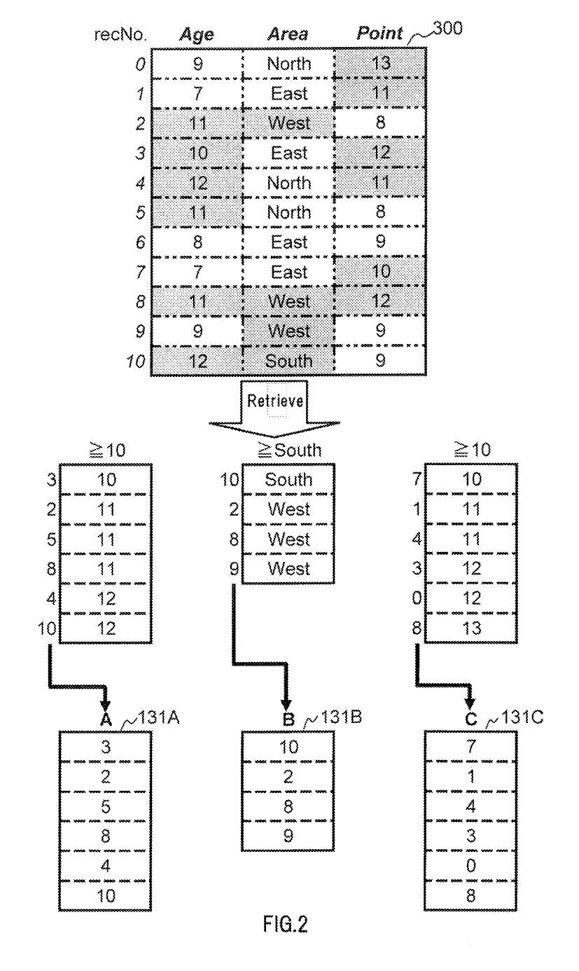

FIG. 2 illustrates an example of the database 300 and the ordered sets 131. As one example here, three ordered sets 131A, 131B, and 131C are shown, retrieved from the database 300 having three items. Hereinafter, the ordered set will be referred to as “131”, if there is no need for distinction between the ordered sets.

As illustrated in this figure, the database 300 is provided with three items; Age, Area, and Point, and the database comprises one or more records, each having at least one item value. It is to be noted that the items of the database 300 are not limited to those examples, and various kinds of items may be available. The item value may be any of a numeric value, a character string, a full text, or the like, as long as it is available as search target information.

The numbers given respectively to the left of the records constituting the database 300 are record numbers (recNo.) uniquely provided to the records, respectively. The record number is information indicating a position where each record is stored in the database 300 that is represented as tabular data. This record number is given, for example, at the time of creating the database 300. Each record is accessible by designating the record number. The record number is an address that does not consume a storage area.

The database 300 is not necessarily held in one storage area. The database may be distributed and stored into plural storage devices. By way of example, in the aforementioned example of the database 300, the records with the record numbers 0 to 3 may be stored in the storage device 130 of the information processor 100, the records with the record numbers 4 to 6 may be stored in the external storage device 160, and the records with the record numbers 7 to 10 may be stored in a storage device of the information processor 180. Alternatively, the age database may be stored in the storage device 130, the area database may be stored in the external storage device 160, and the point database may be stored in the external storage device 190.

The ordered sets 131 are sets of information in the database 300 that is searched for a record satisfying a predetermined condition, using a predetermined item as a key, so as to specify the record that is obtained as a result of searching. In the present embodiment, the record numbers are used as sets of information to identify the records.

In general, as shown in FIG. 2, the search results are likely to be obtained with the item values being arranged in ascending order or in descending order, on the basis of an index mechanism. Therefore, the record numbers stored in the ordered sets 131 are arranged randomly.

Since a typical set is a combination of elements in no particular order, there is no distinction between different orders of the elements, for example, there is no distinction between (1, 2, 3) and (3, 2, 1). The set of the present embodiment, similarly, does not require the order of the elements as a result of the set operation, but at the time when the set is created, information of the order is held in many cases. Since it is necessary to indicate that, in the present embodiment, the operation can be performed even though the order information is held, following discussion will be provided, under the condition that there is a distinction between (1, 2, 3) and (3, 2, 1) as the order of elements. Therefore, in the present embodiment, the set retrieved from the database 300 includes the order of the elements, and it is referred to as “ordered set”.

As shown in FIG. 2, for example, the ordered set 131A is obtained by retrieving from the database 300, records with the item “Age” value being 10 or more, and storing the record numbers thereof. As illustrated, the ordered set 131A holds the record numbers, 3, 2, 5, 8, 4, and 10 in this order.

The ordered set 131B is obtained by retrieving from the database 300, records with the item “Area” value being “South” or “West”, and storing the record numbers thereof. The ordered set 131B holds the record numbers, 10, 2, 8, and 9 in this order.

The ordered set 131C is obtained by retrieving from the database 300, records with the item “Point” value being 10 or more, and storing the record numbers thereof. The ordered set 131C holds the record numbers, 7, 1, 4, 3, 0, and 8 in this order.

It is alternatively possible to configure such that an ID, or the like, is given for uniquely identifying each record of the database 300, other than the record number, and this ID is stored in the ordered sets 131, instead of the record number. It should be noted that the ID needs a storage area, unlike the record number.

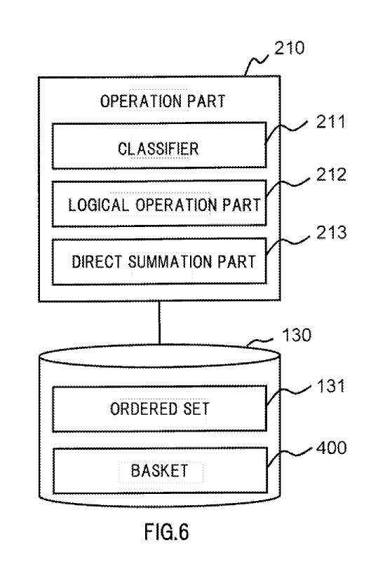

The CPU 110 of the present embodiment implements a function as an operation part 210 (see FIG. 6 described below) configured to execute a logical operation among each of the ordered sets 131, according to programs stored in advance in the storage device 130. The operation part 210 loads the ordered sets 131 in the memory 120, and performs the aforementioned logical operation. It should be noted that data necessary for the operation part 210 to execute the logical operation, data generated during the execution of the logical operation, and the like, are stored in the memory 120 and/or in the storage device 130.

Prior to explaining the logical operation method implemented by the operation part 210 of the present embodiment, a logical operation method (conventional method) according to a conventional information processor will be explained. An explanation will now be made, taking as an example the case where the ordered sets 131A, 131B, and 131C as shown in FIG. 2 are employed, to perform a logical sum OR between the ordered set 131B and the ordered set 131C, and a logical product AND between the logical OR and the ordered set 131A.

Each of the ordered set 131A, 131B, and 131C will now be described using only the final alphabetic characters, A, B, and C, respectively. In an expression of the aforementioned operation, only the alphabetic characters are used for describing the ordered sets. For example, the aforementioned logical operation is expressed as A×(B+C). The same shall apply to the other sets.

Here, the size of each record constituting the ordered sets A, B, and C is assumed as 1, and the size of the memory 120 is assumed as 6 (corresponding to two records of each of the ordered sets A, B, and C), the size allowing the records of the ordered sets A, B, and C to be loaded in the memory when the logical operation is performed in the information processor 100 of the present embodiment.

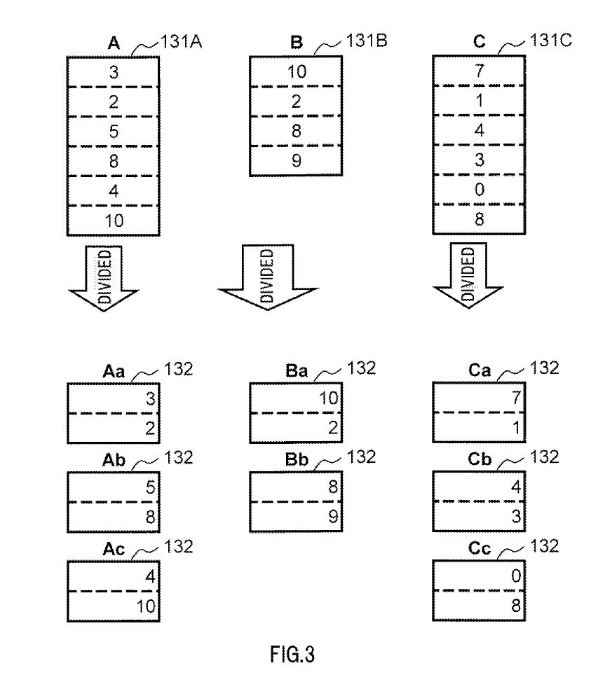

According to this conventional method, as shown in FIG. 3, each ordered sets A, B, and C in which record values are arranged randomly, is divided mechanically from the top, so as to create divided ordered sets 132, each having two records. Then, the logical operation is executed among each of the divided ordered sets 132, the resultant sum is generated, duplicate values are excluded by performing an operation for excluding overlaps, and a result of the operation is outputted. At this time, it is necessary to perform the logical operation on all the combinations of the divided ordered sets 132.

By way of example, as shown in FIG. 3, the ordered set A is divided into three divided ordered sets 132 (Aa, Ab, Ac), each including two records. The ordered set B is divided into two divided ordered sets 132 (Ba, Bb). The ordered set C is divided into three divided ordered sets 132 (Ca, Cb, Cc).

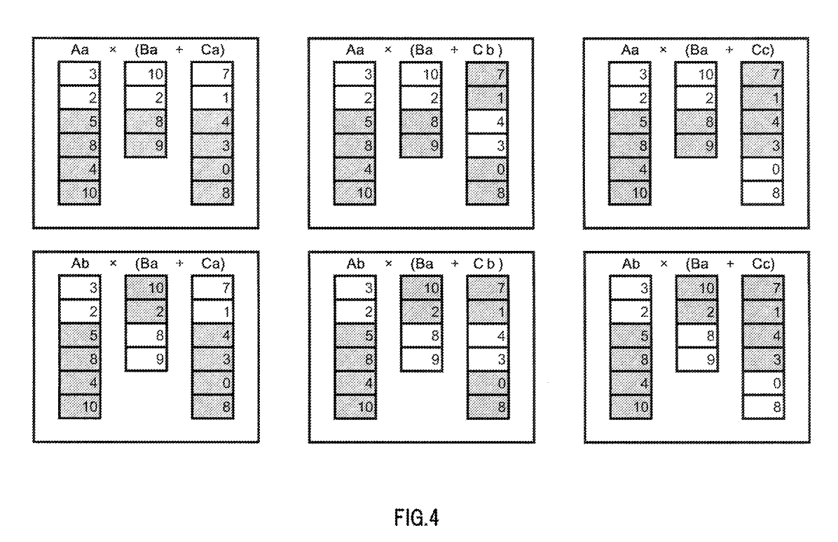

In the conventional method, as shown in FIG. 4, as to the divided ordered set Aa, six times operations of Aa×(Ba+Ca), Aa×(Ba+Cb), Aa×(Ba+Cc), Aa×(Bb+Ca), Aa×(Bb+Cb), and Aa×(Bb+Cc) are performed. Also as for the divided ordered sets Ab and Ac, “Aa” is replaced by “Ab” and “Ac”, respectively, and the six times operations are performed for each set.

Accordingly, 18 times operations as the following are required to be performed:

1) Aa×(Ba+Ca)=(3, 2)×(1, 2, 7, 10)=(2)

2) Aa×(Ba+Cb)=(3, 2)×(2, 3, 4, 10)=(2, 3)

3) Aa×(Ba+Cc)=(3, 2)×(0, 2, 8, 10)=(2)

4) Aa×(Bb+Ca)=(3, 2)×(1, 7, 8, 9)=( )

5) Aa×(Bb+Cb)=(3, 2)×(3, 4, 8, 9)=(3)

6) Aa×(Bb+Cc)=(3, 2)×(0, 8, 8, 9)=( )

7) Ab×(Ba+Ca)=(5, 8)×(1, 2, 7, 10)=( )

8) Ab×(Ba+Cb)=(5, 8)×(2, 3, 4, 10)=(2)

9) Ab×(Ba+Cc)=(5, 8)×(0, 2, 8, 10)=(8)

10) Ab×(Bb+Ca)=(5, 8)×(1, 7, 8, 9)=(8)

11) Ab×(Bb+Cb)=(5, 8)×(3, 4, 8, 9)=(8)

12) Ab×(Bb+Cc)=(5, 8)×(0, 8, 8, 9)=(8)

13) Ac×(Ba+Ca)=(4, 6)×(1, 2, 7, 10)=( )

14) Ac×(Ba+Cb)=(4, 6)×(2, 3, 4, 10)=(4)

15) Ac×(Ba+Cc)=(4, 6)×(0, 2, 8, 10)=( )

16) Ac×(Bb+Ca)=(4, 6)×(1, 7, 8, 9)=( )

17) Ac×(Bb+Cb)=(4, 6)×(3, 4, 8, 9)=(4)

18) Ac×(Bb+Cc)=(4, 6)×(0, 8, 8, 9)=( )

In the conventional operation, the same divided ordered sets 132 are used for the operation repeatedly. In the example above, for instance, the divided ordered set Aa is used six times, the divided ordered set Ab is used six times, the divided ordered set Ac is used six times, the divided ordered set Ba is nine times, the divided ordered set Bb is used nine times, the divided ordered set Ca is used six times, the divided ordered set Cb is used six times, and the divided ordered set Cc is used six times for the operation.

As a general formulation, it is necessary to perform the logical operation for P times that is expressed as the following formula 1:

$$\begin{matrix}[ Formula 1 ] & \\ P = {\prod }_{k = 1}^{K} \frac{{N}_{k}}{{M}_{k}} & ( 1 )\end{matrix}$$

where the number of all the ordered sets is K (K is an integer equal to or larger than 1), the number of the records of the k-th ordered set is Nk (Nk is an integer equal to or larger than 1), the number of the records of the k-th ordered set allocatable to the memory, per ordered set, is Mk (Mk is an integer equal to or larger than 1). Therefore, this may cause an enormous number of accesses to the memory 120, such as reading from the storage device 130 to the memory 120, and writing from the memory 120 to the storage device 130.

In the aforementioned 18 times operations, the number of reading times is a product of the number of records of each divided ordered set 132 and the number of operations. Therefore, in the above example, the number of reading times is equal to 6×18, that is, 108 times. The number of writing is equal to the sum of the number of records being the results of the operation. Therefore, in the above example, the number of writing times is equal to the sum of 1, 2, 1, 0, 1, 0, 0, 1, 1, 1, 1, 1, 0, 1, 0, 0, 1, and 0 times, that is, 12 times. As described above, in the conventional method, 120 times of reading and writing processes in total are performed for the operation only.

Further, according to the conventional method, merging of the obtained results is not a direct sum. In other words, the 18 times operation results are summed up to obtain the set (2, 2, 3, 2, 3, 2, 8, 8, 8, 8, 4, 4), and overlaps are excluded to eliminate duplicate values from the set to obtain the set (2, 3, 4, 8) as the operation result.

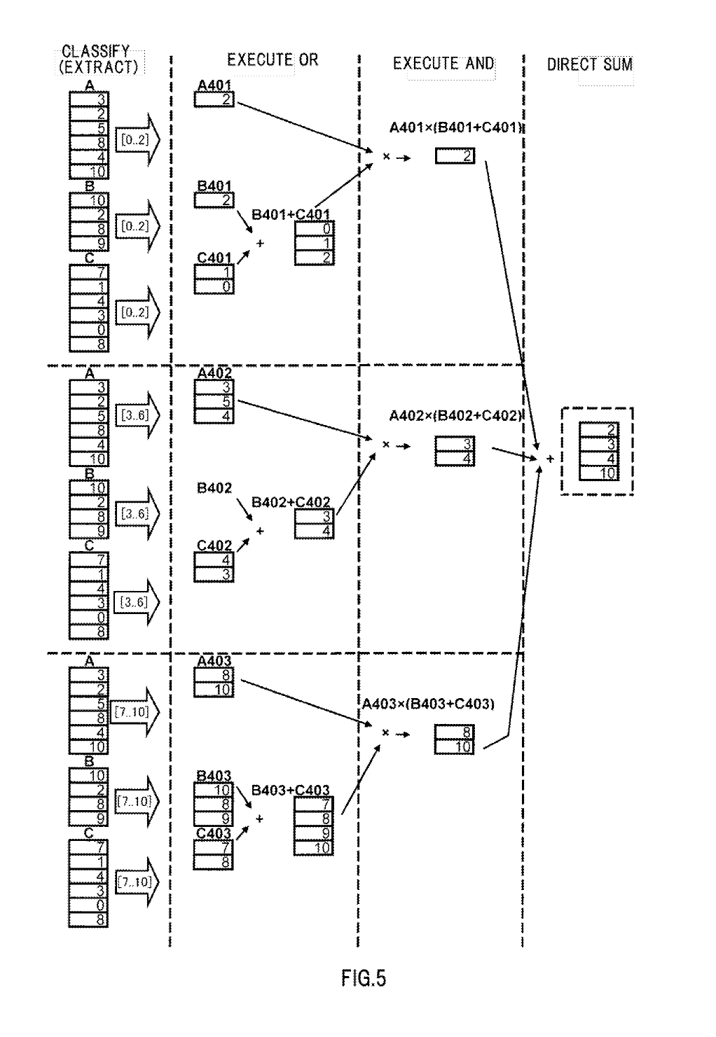

Next, a processing according to the operation part 210 of the present embodiment will be described. FIG. 5 schematically illustrates the processing according to the operation part 210 of the present embodiment. As illustrated, firstly in the present embodiment, the records constituting each ordered set 131 are classified (categorized) into common segments. Hereinafter, the segment into the records are categorized is referred to as a “basket”. The logical operation is executed for each basket, and finally, the direct sum of the logical operation results of all the baskets is calculated.

In the present embodiment, similar to the conventional method, the records in each of the ordered sets 131 are divided into a size that is allocatable in the memory 120. However, the division is not made mechanically on the basis of the number of records, but in accordance with a value of the record, and the records are classified and categorized into one or more basket being predetermined, in such a manner that there are no duplicate records.

In order to implement the feature above, as shown in FIG. 6, the operation part 210 of the present embodiment is provided with a classifier 211 configured to sort and classify all the records belonging to plural ordered sets 131 into each of the baskets 400, a logical operation part 212 configured to perform a logical operation on each of the baskets 400, and a direct summation part 213 configured to calculate a direct sum of results of the logical operation as to the baskets 400 respectively. It is to be noted that the baskets 400 are provided in the storage device 130.

Only the record that satisfies a predetermined condition (sorting condition) is sorted into each of the baskets 400. The sorting condition for each of the baskets 400 is determined, as described above, in such a manner that all the records in all the ordered sets 131 are sorted (categorized) uniquely. That is, the condition is determined so that all the records in all the ordered sets 131 are completely covered, as well as classified without duplication.

By way of example, a range of the record value, a remainder (residue) obtained by dividing a value of the record by a predetermined integer equal to or larger than two, or the like, may be used as the sorting condition.

The sorting condition, the size of the basket 400, and the number the baskets are defined in advance. Here, the size of the basket 400 and the number thereof are configured on the basis of the record values of all the ordered sets 131, and the size of the memory 120 used for the logical operation. By way of example, the size of the basket 400 is determined, in such a manner that a total size of all the records classified into the baskets 400 does not exceed the size of the memory 120.

In the logical operation, when a generally-used bitmap is employed, an additional processing variable (a work area) is not required in finding both the sum and multiplication product. The bitmap uses the same area, whichever the set is large or small, and there is only a difference whether there are many one-bits or not. Therefore, the size of the basket 400 may take M/N at the maximum, where an available amount of memory is M and the number of sets is N.

By way of example, when the sorting condition relates to the range of record values, the width of the range is determined in accordance with the size of the memory 120. When the sorting condition relates to a remainder, a divisor is determined in accordance with the size of the memory 120.

If the number of the baskets is large, the amount of operation at a time is decreased, and if the number of baskets is small, the amount of operation at a time is increased. Therefore, the amount of operation is irrelevant to the number of baskets, but less number of the baskets 400 is generally advantageous, because it reduces I/O switching frequency. Here, the minimum number of the baskets 400 is equal to N×T/M, where the size of the total sets is T, and T is divided by M/N being the size of the basket 400.

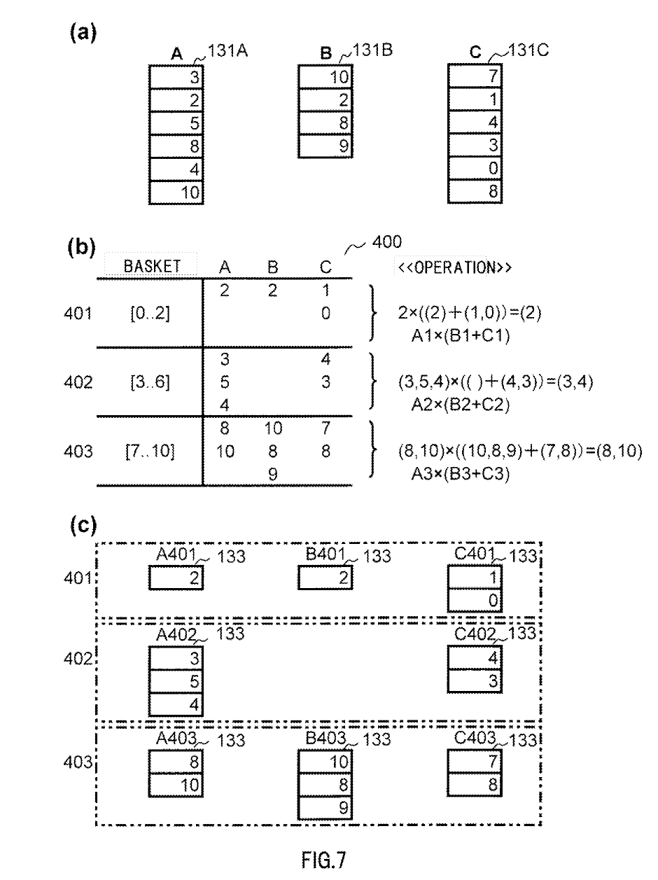

As shown in FIG. 7(a), the classifying process by the classifier 211 of the present embodiment will now be specifically described, by using the three ordered sets A, B, and C that are shown in FIG. 2. The logical operation executed here is assumed as A×(B+C), similar to the aforementioned description of the conventional method.

As shown in FIG. 7 (b), it is assumed here that the sorting condition of each of the baskets 400 relates to the range of record values. In other words, a record whose value falls into the record value range designated by the sorting condition is sorted into the basket 400.

As one example here, there are prepared three baskets 401, 402, and 403. The sorting condition for the first basket 401 is that the record value falls into the range [0 to 2], that is, the record value is any of (0, 1, 2), the sorting condition for the second basket 402 is that the record value falls into the range [3 to 6], that is, the record value is any of (3, 4, 5, 6), and the sorting condition for the third basket 403 is that the record value falls into the range [7 to 10], that is, the record value is any of (7, 8, 9, 10).

As shown in FIG. 7(b), the classifier 211 of the present embodiment classifies the records into each of the baskets 401, 402, and 403, in the order of the record number with respect to each ordered set A, B, and C. As for the ordered set A, the record of the record number 1 with the value 2 (simply referred to as “record 2”) is classified into the first basket 401 [0 to 2], the record 3 of the record number 0, the record 5 of the record number 2, and the record 4 of the record number 4 are classified into the second basket 402 [3 to 6], and the record 8 of the record number 3 and the record 10 of the record number 5 are classified into the third basket 403 [7 to 10].

As shown in FIG. 7(b), the records in the ordered set B and the ordered set C are similarly categorized into the baskets 401, 402, and 403, respectively.

FIG. 7(c) shows a partial ordered set 133 of each of the ordered sets 131 after the classification. As illustrated, the ordered set A is divided (partitioned) into the partial ordered set 133 (A401) classified in the first basket 401, the partial ordered set 133 (A402) classified in the second basket 402, and the partial ordered set 133 (A403) classified in the third basket 403. Similarly, the ordered set B is divided into the partial ordered set 133 (B401) and the partial ordered set 133 (B403), and the ordered set C is divided into the partial ordered set 133 (C401), the partial ordered set 133 (C402), and the partial ordered set 133 (C403).

The logical operation part 212 of the present embodiment performs the logical operation with respect to each basket. In other words, in the example of FIG. 7(b), the logical operation is performed among the records within each of the first basket 401, the second basket 402, and the third basket 403. Here, three operations as the following are performed:

1) A401×(B401+C401)=(2)×(2,1,0)=(2)

2) A402×(B402+C402)=(3,5,4)×(3,4)=(3,4)

3)A403×(B403+C403)=(8,10)×(7,8,9,10)=(8,10)

In the present embodiment, as described above, categories in the respective baskets 400 (401, 402, 403) do not overlap. Therefore, a result of the logical operation within one of the baskets 400 is consistently independent of and separated from that of the other baskets 400. Then, the direct summation part 213 of the present embodiment calculates the direct sum of the logical operation results of the respective baskets 400 (401, 402, and 403), and a result of the calculation is obtained. In the example above, ((2)+(3, 4)+(8, 10)) is calculated, and the operation result (2, 3, 4, 8, 10) is obtained.

It should be noted that in the present embodiment, when sorting into the baskets 400, each record is read from the storage device 130 to the memory 120, and it is determined into which basket 400 the record is sorted. Then, the record is written in the basket area in the storage device 130. Therefore, reading from the storage device 130 to the memory 120, and writing from the memory 120 to the storage device 130 are required to be executed, for the number of counts, corresponding to the number of records. In the example above, 16 times for each, that is, 32 times of reading and writing are necessary in total.

However, in the operation example above, the number of counts each partial ordered set is used for the logical operation is obviously “proportional” to the size of all the ordered sets, and each partial set is used just once, which is basically different from the polynomial order of the conventional technique as expressed by the formula (1). The total count of the logical operation is three times, as described above. While the operation is performed three times, the reading count is 16 which is a product of the number of records in each of the partial ordered sets and the count of the logical operation, and the writing count is 5, which is the sum of the number of records in the operation result, i.e., 1, 2, and 2 times. Therefore, reading and writing in the logical operation is 21 times in total.

Therefore, according to the present embodiment, when the logical operation A×(B+C) is executed among the ordered set A, B, and C as shown in FIG. 2, the reading and writing process are required to be performed only 53 times, which is the sum of 32 times upon sorting, and 21 times when the logical operation is performed. Compared to the case where 120 times is needed under the same condition in the conventional method, the number of accesses to the memory is reduced dramatically.

Further according to the present embodiment, when result sets are integrated after executing the logical operation among each of the partial ordered sets 133, it is not necessary to perform an operation for excluding duplicate values, which consumes large memory and also time-consuming, and only calculating the direct sum leads to a result. Therefore, the present embodiment is efficient.

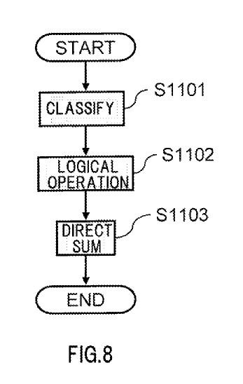

With reference to FIG. 8, a flow of the logical operation process among the ordered sets 131 according to the operation part 210 of the present embodiment will be described. Firstly, the classifier 211 scans the records sequentially from the top in each of the ordered sets 131 and classifies the records, so as to sort them into each of the baskets 400 (step S1101). Next, the operation part 212 loads the records in the memory 120, assuming the basket 400 as a unit, and performs the logical operation (step S1102). Results of the logical operation are stored in the storage device 130, or the like. Finally, the direct summation part 213 loads the results of the logical operation in the memory 120, and calculates the direct sum thereof (step S1103).

As described above, the information processor 100 of the present embodiment performs the logical operation among plural ordered sets 131, and the information processor is provided with the classifier 211 configured to classify the records constituting the ordered sets 131 into the predetermined segments (baskets) 400, with respect to each ordered set 131, the logical operation part 212 configured to subject the records of the ordered sets 131 belonging to the same segment (basket) 400, to the logical operation, so as to obtain operation results, and the direct summation part 213 configured to calculate a direct sum of the operation results of the segments (baskets) 400, wherein the segment (basket) 400 allows all the records belonging to the plural ordered sets 131 to be categorized uniquely.

As thus described, according to the present embodiment, the records in each of the ordered sets 131 are classified into the segments not overlapping each other, and the logical operation is performed on the basis of the segments. In this case, the segment is assumed to be in the size that is loadable in the memory 120.

According to the present embodiment, the writing process to the basket 400 and the reading process from the basket 400 at the time of the logical operation are additional processes, but each operation process is executable, by only a single time loading in the memory 120. Furthermore, only the number of baskets 400 is sufficient as the number of the operations. Therefore, unlike the conventional method, it is not necessary to perform the operation as to all the combinations as to each divided unit. As discussed above, according to the present embodiment, it is possible to reduce the number of the operations. In addition, since the operation count is reduced, the number of accesses to the memory 120 in every operation is also reduced. Furthermore, the operation for excluding duplicate values to obtain a final result is not necessary any more.

Therefore, according to the present embodiment, it is possible to execute the logical operation at high speed and efficiently, on the ordered sets 131 which are too large to load in the memory 120, being created from big data.

It is to be noted that in the aforementioned embodiment, all the ordered sets 131 are categorized into the baskets 400, but this is not the only example. By way of example, the ordered set 131 in a size equal to or smaller than a predetermined size (the ordered set including records the number of which is equal to or less than a predetermined number) may not be categorized, but the logical operation may be performed on the ordered set without any change.

In the example above, for instance, only the ordered sets A and C are categorized, without categorizing the ordered set B, and the logical operation is performed thereon. In this case, in the first basket 401, 2×((10, 2, 8, 9)+(1, 0)) is calculated as A×(B+C), and the operation result (2) is obtained. In the second basket 402, (3, 5, 4)×((10, 2, 8, 9)+(4, 3)) is calculated, and the operation result (3, 4) is obtained. In the third basket 403, (8, 10)×((10, 2, 8, 9)+(7, 8)) is calculated, and the operation result (8, 10) is obtained.

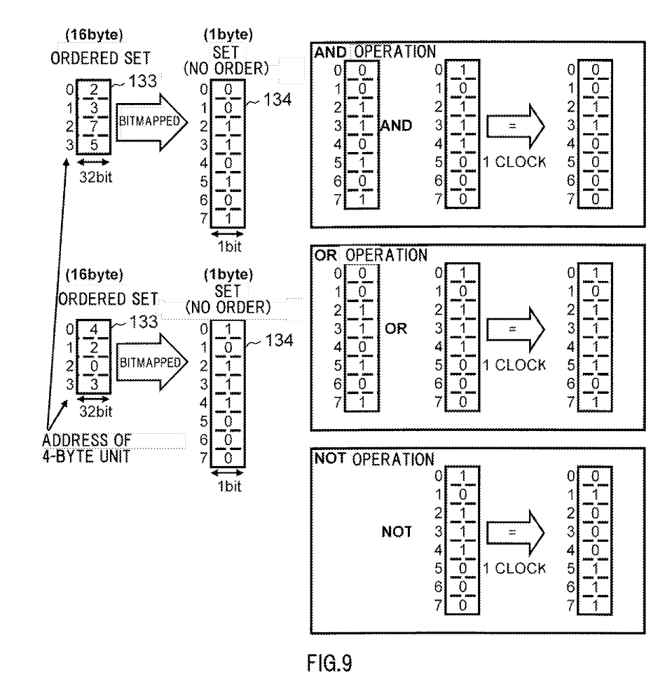

In the aforementioned embodiment, it is effective to perform the logical operation, after loading the records in the memory 120 as a bitmap, as shown in FIG. 9. In other words, as illustrated, each of the partial ordered set 133 as a target of the logical operation is loaded in the form of the bitmap 134, and the operation is performed as shown in the figure.

In the aforementioned embodiment, an explanation has been made taking as an example that only the logical product (AND) and the logical sum (OR) are used, but the logical operation is not limited to this example. By way of example, negation (NOT) may be used. The NOT operation may be easily implemented by inverting the bitmap. By way of example, if the ordered set A=(4, 2, 0, 3), those are removed from the range of the basket 400, and ˜A=(1, 5, 6, 7) is obtained. Here, represents negation (NOT). It is obvious that various set operations may be performed by utilizing this NOT operation.

In addition, each of the baskets 400 may be established in another information processor being connected via the network 171, or the like. In this case, each information processor where the basket 400 is established is provided with the logical operation part 212, and the logical operation is performed on the data within this basket 400.

In the aforementioned embodiment, a storage area referred to as the basket 400 is practically provided, and the records are sorted therein, but this is not the only example. It is further possible to configure such that the classifier 211 scans each of the ordered sets 131 when the logical operation is performed, and extracts records to be sorted into the basket 400 that is a target of the logical operation. In this case, the classifier 211 scans the ordered set 131, for the number of times, corresponding to the number of the baskets 400.

### EXPLANATION OF REFERENCES

100: information processor, 110: CPU, 120: memory, 130: storage device, 131: ordered set, 132: divided ordered set, 133: partial ordered set, 134: bit map, 140: input device, 150: output device, 160: external storage device, 170: network interface, 171: network, 180: information processor, 190: external storage device, 210: operation part, 211: classifier, 212: operation part, 212: logical operation part, 213: direct summation part, 300: database, 400: basket, 401: first basket, 402: second basket, 403: third basket, A401: partial ordered set, A402: partial ordered set, A403: partial ordered set, B401: partial ordered set, B402: partial ordered set, B403: partial ordered set, C401: partial ordered set, C402: partial ordered set, C403: partial ordered set

1. A logical operation method among plural sets, comprising,
classifying records constituting the sets, into predetermined segments, with respect to each of the sets, subjecting the records belonging to the same segment to a logical operation among the sets, obtaining operation results, and calculating a direct sum of the operation results of the respective segments, wherein,
the segment allows all the records belonging to the plural sets to be categorized uniquely.

2. The logical operation method according to claim 1, wherein,
when the logical operation is performed, a size of the segment is determined in accordance with a size of a memory for loading.

3. The logical operation method according to claim 2, wherein,
the size of the segment is determined in such a manner that a total size of all the records classified into the segment does not exceed the size of the memory.

4. The logical operation method according to claim 1, wherein,
the segment is defined by a value range of the records.

5. The logical operation method according to claim 1, wherein,
the segment is defined by a residue that is obtained by a division with a predetermined integer equal to or larger than two.

6. An information processor for performing a logical operation among plural sets, comprising,
a classifier configured to classify all records constituting the sets into predetermined segments, with respect to each of the sets,
a logical operation part configured to subject the records belonging to the same segment to a logical operation among the sets, and obtain an operation result, and
a direct summation part configured to calculate a direct sum of the operation results of the respective segments, wherein,
the segment allows all the records belonging to the plural sets to be categorized uniquely.

7. A program causing a computer to function as,
a classifying means configured to classify all records belonging to plural sets, with respect to each of the sets, into segments that allow the records to be categorized uniquely,
a logical operation means configured to subject the records belonging to the same segment to a predetermined logical operation among the sets, and obtain a result of the operation, and
a direct sum means configured to calculate a direct sum of the operation results of the respective segments.
